(19) United States
(12) Patent Application Publication
(10) Pub. No.: US 2024/0260566 A1
(43) Pub. Date: Aug. 8, 2024

(54) POLE CLIMBING INHIBITING DEVICE

(71) Applicant: Michael Trachuk, Lacorey (CA)

(72) Inventor: Michael Trachuk, Lacorey (CA)

(21) Appl. No.: 18/165,368

(22) Filed: Feb. 7, 2023

(51) Int. Cl. A01M 29/30

(52) U.S. Cl. CPC A01M 29/30

(57) ABSTRACT

A device configured to be secured to a utility pole or tree wherein the device inhibits an animal from climbing up the tree past the location of the device. The present invention includes a base member wherein the base member is circumferentially disposed around a utility pole and secured thereto. The base member has secured thereto a plurality of arm member brackets wherein the arm member brackets extend outward from the base member. A plurality of arm members are movably coupled to the arm member brackets and are movable between a first position and a second position. In the first position the arm members are adjacent the utility pole. In the second position the arm members are extended outward from the base member. A movement cable is operably coupled to the arm members to provide movement thereof.

### FIELD OF THE INVENTION

The present invention relates generally to pole safety, more specifically but not by way of limitation, a device configured to be mounted to a pole such as but not limited to a utility pole, wherein the device is operable to inhibit wild animals from ascending the pole upwards past the location of the device.

### BACKGROUND

As is known in the art, utility poles are still quite commonly utilized to routing of utilities such as but not limited to electrical and communication wire. While some areas in North America deploy utilities underground, a large percentage of utilities are deployed with poles placing the wire well above ground. There are two commonly utilized utility poles wherein one is manufactured from aluminum or other metal while the other is manufactured from wood. Wood utility poles are more commonly utilized in many areas and are manufactured from Douglas fir trees or other suitable wood.

One issue with wood utility poles is that wildlife can climb up the pole much like the wildlife climbs up a tree. Wildlife such as bear and large wildcats often climb trees to forage or for other reasons. It is common for a bear to climb up to the top of a utility pole and during the process make contact with equipment such as but not limited to a transformer. This contact with equipment on the utility pole can result in damage to the animal and the equipment. It is common for bears to start fires which results in death to the bear as well as destruction of the equipment. These wildlife species also climb trees in pursuit of hunters that may be positioned in a tree for hunting. When a wild animal climbs a tree to pursue an individual, there is no device to inhibit the wild animal from ascending the tree as needed to reach the individual perched in the tree,

Accordingly, there is a need for a device that can be mounted to a utility pole or tree wherein the device is configured to inhibit an animal from ascending the pole or tree past the location where the device is mounted.

### SUMMARY OF THE INVENTION

It is the object of the present invention to provide a device configured to inhibit an animal from climbing a pole wherein the present invention includes a base member.

Another object of the present invention is to provide a climbing prevention device operable to inhibit animals from climbing up a utility pole wherein the base member is circumferentially disposed around the pole.

Yet a further object of the present invention is to provide a device configured to inhibit an animal from climbing a pole wherein the base member has secured thereto a plurality of arm member brackets.

Still another object of the present invention is to provide a climbing prevention device operable to inhibit animals from climbing up a utility pole wherein the arm member brackets extend outward from the base member.

An additional object of the present invention is to provide a device configured to inhibit an animal from climbing a pole that further includes a plurality of arm members movably coupled to the arm member brackets.

Yet a further object of the present invention is to provide a climbing prevention device operable to inhibit animals from climbing up a utility pole wherein the arm members are operable coupled to a movement cable.

Another object of the present invention is to provide a device configured to inhibit an animal from climbing a pole wherein the movement cable is operable to move the arm members between a first position and a second position.

Still an additional object of the present invention is to provide a climbing prevention device operable to inhibit animals from climbing up a utility pole wherein in the second position the arm members are extended outward from the base member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention in its second position; and

FIG. 2 is a perspective view of the present invention in its first position.

### DETAILED DESCRIPTION

Referring now to the drawings submitted herewith, wherein various elements depicted therein are not necessarily drawn to scale and wherein through the views and figures like elements are referenced with identical reference numerals, there is illustrated climbing inhibitor 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the climbing inhibitor 100 is illustrated herein being operably coupled to an exemplary utility pole 99. It should be understood within the scope of the present invention that the climbing inhibitor 100 could be installed on a utility pole 99 or be employed in other applications wherein the climbing inhibitor 100 is mounted to a portion of a tree. The climbing inhibitor 100 includes a base member 10. The base member 10 is manufactured from a suitable material such as but not limited to metal flat bar. The base member 10 is formed in an annular shape so as to be circumferentially disposed around the utility pole 99. It should be understood within the scope of the present invention that the base member 10 could be provided in alternate diameters in order to facilitate mounting thereof to alternate size utility poles or trees. It should be further understood within the scope of the present invention that the base member 10 could be mounted to the utility pole 99 utilizing various types of mechanical fasteners to either permanently or temporarily mount the climbing inhibitor 100.

Secured to the exterior surface 11 of the base member 10 are a plurality of arm member brackets 20. The arm member brackets 20 include a first lateral support member 21 and a second lateral support member 22 that are mounted perpendicular to the base member 10 and extend outward therefrom. As is further discussed herein, the arm member brackets 20 have arm members 30 movably coupled thereto. The arm member brackets 20 are disposed around the complete circumference of the base member 10. It should be understood within the scope of the present invention that the climbing inhibitor 100 could include alternate quantities of arm member brackets 20 as desired for a particular application and/or shape of the arm member 30. It should be further understood within the scope of the present invention that the arm member brackets 20 could be manufactured in alternate forms and still achieve the desired objective discussed herein.

The arm members 30 are movably secured to the arm member brackets 20 and are operable to move between a first position and a second position. The arm members 30 are generally rectangular in shape being planar in form and are manufactured from a suitable rigid material such as but not limited to metal flat bar. The arm members 30 include a first end 31 and second end 32. It is contemplated within the scope of the present invention that the arm members 30 could be provided in different widths. Furthermore, it is additionally contemplated within the scope of the present invention that the arm members 30 could be formed in alternate shapes than what is illustrated herein. By way of example but not limitation, the second end 32 area of the arm member 30 could have a width that is greater than the first end 31. A greater width of the second end 32 of the arm member 30 would facilitate increased coverage with fewer arm members 30. It is further contemplated within the scope of the present invention that the arm members 30 could be manufactured in alternate lengths based on application need.

Secured to the first end 31 of the arm member 30 is a keeper 40. Keeper 40 is manufactured from a suitable rigid material and is secured to the upper surface of the arm member 30 utilizing suitable techniques. The keeper 40 includes aperture 41 wherein aperture 41 is of sufficient size so as to receive movement cable 50 therethrough. It is contemplated within the scope of the present invention that the keeper 40 could be constructed in alternate forms in order to achieve the objective of operably coupling the arm members 30 to the movement cable 50.

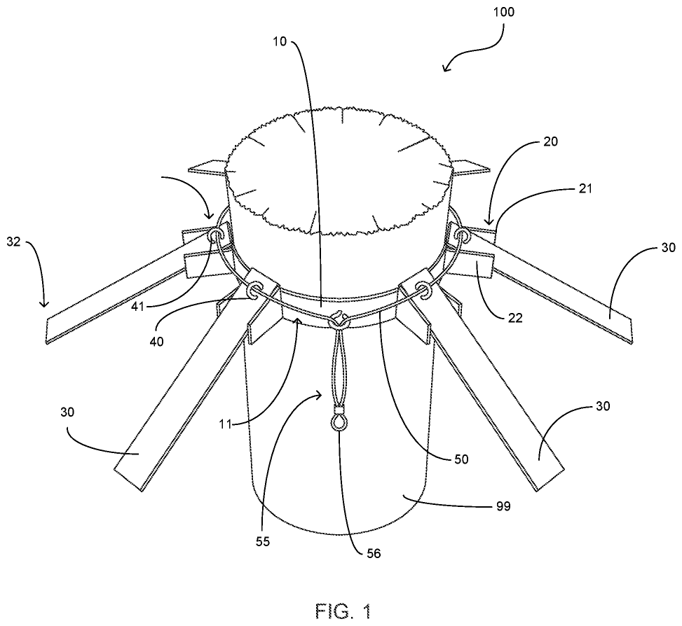

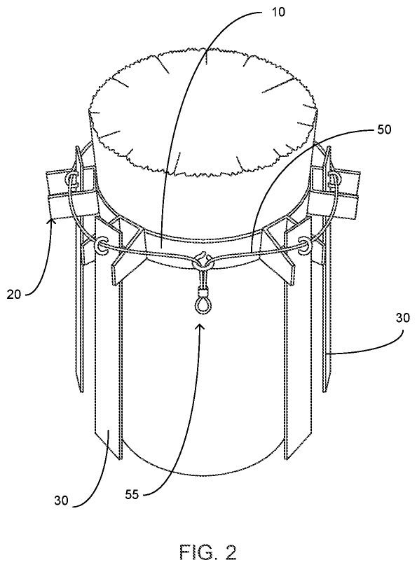

The movement cable 50 is a conventional steel cable that is operably coupled to each keeper 40 secured to each arm member 30. The movement cable 50 includes end 55 that is configured to join the movement cable 50 ends as is illustrated herein. The end 55 provides the structure and interface for a user of the climbing inhibitor 100 to move the arm members 30 from a first position to a second position. FIG. 2 submitted herewith illustrates the arm members 30 in the first position. In the first position, the arm members 30 are adjacent the utility pole 99 and the end 55 of the movement cable 50 is proximate the base member 10. The second position of the arm members 30 is illustrated herein in FIG. 1. In the second position of the arm members 30, the arm members 30 are extended outward from the base member 10 utilizing a downward force on the end 55 resulting in a lower position thereof relative to the base member 10 as illustrated in FIG. 1. End 55 is configured with loop 56 wherein the loop 56 provides a technique to hold the arm member 30 in their second position. Loop 56 can be operably coupled to a stud or other protrusion on the utility pole 99 in order to maintain the end 55 in its downward position so as to sustain the arm members 30 in their second position. It is contemplated within the scope of the present invention that end 55 could be configured in alternate manners in order to achieve the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A device configured to be operably coupled to an object capable of being climbed so as to inhibit an animal from climbing therepast wherein the device comprises:
a base member, said base member being circumferentially disposed around the object, said base member being secured to the object, said base member having an outer surface;
a plurality of arm member brackets, said arm member brackets being mounted to said outer surface of said base member, said plurality of arm member brackets extending outward from said base member;
a plurality of arm members, said plurality of arm members being movably coupled to said plurality of arm member brackets, said plurality of arm members having a first end and a second end, said first end of said plurality of arm members being proximate said plurality of arm member brackets, said plurality of arm members being movable between a first position and a second position; and
wherein in said second position said plurality of arm members inhibit an animal from climbing past the device.

2. The device configured to be operably coupled to the object capable of being climbed so as to inhibit an animal from climbing therepast as recited in claim 1, wherein said plurality of arm members further include a keeper, said keeper being mounted to an upper surface of said plurality of arm members, said keeper being proximate said first end of said plurality of arm members.

3. The device configured to be operably coupled to the object capable of being climbed so as to inhibit an animal from climbing therepast as recited in claim 2, and further including a movement cable, said movement cable being operably coupled to said keeper on said plurality of arm members.

4. The device configured to be operably coupled to the object capable of being climbed so as to inhibit an animal from climbing therepast as recited in claim 3, wherein said movement cable includes an end, said end of said movement cable further including a loop.

5. The device configured to be operably coupled to the object capable of being climbed so as to inhibit an animal from climbing therepast as recited in claim 4, wherein said movement cable is operable to move the plurality of arm members between their first position and their second position.

6. The device configured to be operably coupled to the object capable of being climbed so as to inhibit an animal from climbing therepast as recited in claim 5, wherein in said first position said plurality of arm members are adjacent to the object.

7. The device configured to be operably coupled to the object capable of being climbed so as to inhibit an animal from climbing therepast as recited in claim 6, wherein in said second position said plurality of arm members are extended outward from said base member.

8. The device configured to be operably coupled to the object capable of being climbed so as to inhibit an animal from climbing therepast as recited in claim 7, wherein said loop member is operable to engage an element on the object so as to maintain the plurality of arm members in said second position.
